(19) United States
(12) Patent Application Publication
(10) Pub. No.: US 2026/0112044 A1
(43) Pub. Date: Apr. 23, 2026

(54) Alignment of Point Clouds Representing Physical Objects

(71) Applicant: Telefonaktiebolaget LM Ericsson (publ), Stockholm (SE)

(72) Inventors: Volodya Grancharov, Solna (SE); Fengkai Wan, Bromma (SE); Jiangning Gao, Solna (SE); Rerngvit Yanggratoke, Järfälla (SE)

(21) Appl. No.: 18/705,142

(22) PCT Filed: Nov. 3, 2021
(86) PCT No.: PCT/EP2021/080478

§ 371 Date: Apr. 26, 2024

(51) Int. Cl. G06T 7/33; G06T 5/50; G06T 5/70

(52) U.S. Cl. CPC G06T 7/33; G06T 5/50; G06T 5/70; G06T 2207/10028; G06T 2207/10032; G06T 2207/30184

(57) ABSTRACT

There is provided mechanisms for aligning point clouds (PCs) of a physical object. A method is performed by an image processing device. The method comprises obtaining PCs (S102). Each PC comprises data points and each PC is generated from a respective set of two-dimensional (2D) digital images captured of the physical object. The method comprises localizing (S106), in the PCs, data points that correspond to feature points of visual features comprised in the 2D digital images. The method comprises selecting (S108) at least one of the localized data points in each of the PCs as a reference point. The reference points across the PC's represent the same visual feature comprised in the 2D digital images. The method comprises aligning the PCs with each other by aligning the reference points across the PCs with each other (Slid, 410a, 410b, 440).

### TECHNICAL FIELD

Embodiments presented herein relate to a method, an image processing device, a computer program, and a computer program product for aligning point clouds of a physical object.

### BACKGROUND

Within the technical field of digital imaging, a point cloud (PC) can, in general terms, be regarded as a set of data points in space. The points represent a three-dimensional (3D) shape or object. In other words, a PC is a 3D PC. Hereinafter it will be assumed that the point cloud represents a physical object. Dense point clouds (DPCs) are point clouds with comparably high number of data points than sparse point clouds (SPCs), yielding high resolution of the physical object. Each point in the PC has a set of coordinates. PCs are generally produced by 3D scanners or by photogrammetry software, which measure many points on the external surfaces of the physical object. As the output of 3D scanning processes, PCs are used for many purposes, including to create 3D computer aided design (CAD) models for manufactured parts, for metrology and quality inspection, and for a multitude of visualization, animation, rendering and mass customization applications.

As the output of 3D scanning processes, PCs are used for many purposes, including to create 3D computer aided design (CAD) models for manufactured parts, for metrology and quality inspection, and for a multitude of visualization, animation, rendering and mass customization applications.

One benefit of using PCs will be now be illustrated. FIG. 1 schematically illustrates different views, taken from different types of orbits, of a telecommunication site, commonly referred to as a base station. Assume that a comparison is to be made between the telecommunication site and schematics of the telecommunication site. One way to achieve this is to generate one or more PCs of the telecommunication site and then comparing the one or more PCs to the schematics.

Previously, this process would have involved a human operator, technician, or engineer, performing a survey, involving a site visit, or even climbing up the physical structure of the site, and then creating a site drawing. The site drawing would represent the physical structure and properties of the site. An example of a site drawing is provided in FIG. 2. At FIG. 2(a) is shown a sideview of a telecommunication site 100, where the telecommunication site 100 comprises an antenna system 120 and a tower construction 130. At FIG. 2(b) is shown a top view of the antenna system 120 in FIG. 2(a), taken along the cut A-A. The site drawing could be compared to the schematics. This process is tedious and expensive, as well as potentially dangerous as the human operator needs to climb the physical structure.

PCs can be aligned with other PCs, a process known as point set, or PC, registration, fusion, or alignment. Hereinafter, alignment will refer to the process of aligning different PCs with each other. In some aspects, the input to the process of aligning different PCs with each other are input PCs that have been generated from a respective set of two-dimensional (2D) digital images, as well as the sets of 2D digital images. In some aspects, the input PCs fulfil a certain scaling property that a same physical object should have similar dimensions across the input PCs. If the input PCs do not fulfil the scaling properties, some of the input PCs can be scaled accordingly. The output of the process is a fused, or combined, PC from all the input PCs. The aligning essentially considers finding the most appropriate transformation in terms of rotation and translation in 3D space of the input PCs.

There could be different ways to perform the point set registration, fusion, or alignment of different PCs, or DPCs. Some non-limiting examples are algorithms based on a per data point criterion, i.e., where the PCs are aligned based on distance between individual points of the PCs to be aligned. Iterative Closest Point (ICP) and its variants are some non-limiting examples of algorithms based on the per data point criterion. A comprehensive survey of further non-limiting examples of ways to perform the point set registration, fusion, or alignment of different PCs are mentioned in the article “A comprehensive survey on point cloud registration” by Huang, X. et al, made available by arXiv.org; https://arxiv.org/pdf/2103.02690.pdf (as accessed on 22 Oct. 2021).

However, due to its inherent design, the original ICP algorithm is sensitive to correct initialization of the PCs. Further, the original ICP algorithm is only capable of aligning PCs that are already relatively close to each other. As a non-limiting example, and making reference again back to the examples illustrated in FIG. 1, relatively inaccurate location information from the 2D digital images might result in each individual PC reconstructed from two different orbits to be far away, or rotated, relative each other. This might cause difficulties in finding matching data points by using ICP. Further, the lightning conditions for the 2D digital images for the different orbits might vary. In turn, this might result in inconsistent density of each PC. For example, more data points can be reconstructed if the illumination is lighter and hence the density of data points might vary between the different PCs. The original ICP algorithm might have difficulties to converge using PCs with mutually different density of data points. These issues and more might lead to failure of alignment or shadowing (or ghosting) effects in the aligned PC.

Hence, there is still a need for improved techniques for constructing PCs from images of physical objects.

### SUMMARY

An object of embodiments herein is to address the above-mentioned problems.

According to a first aspect there is presented a method for aligning PCs of a physical object. The method is performed by an image processing device. The method comprises obtaining PCs. Each PC comprises data points and each PC is generated from a respective set of 2D digital images captured of the physical object. The method comprises localizing, in the PCs, data points that correspond to feature points of visual features comprised in the 2D digital images. The method comprises selecting at least one of the localized data points in each of the PCs as a reference point. The reference points across the PCs represent the same visual feature comprised in the 2D digital images. The method comprises aligning the PCs with each other by aligning the reference points across the PCs with each other.

According to a second aspect there is presented an image processing device for aligning PCs of a physical object. The image processing device comprises processing circuitry. The processing circuitry is configured to cause the image processing device to obtain PCs. Each PC comprises data points and each PC is generated from a respective set of 2D digital images captured of the physical object. The processing circuitry is configured to cause the image processing device to localize, in the PCs, data points that correspond to feature points of visual features comprised in the 2D digital images. The processing circuitry is configured to cause the image processing device to select at least one of the localized data points in each of the PCs as a reference point. The reference points across the PCs represent the same visual feature comprised in the 2D digital images. The processing circuitry is configured to cause the image processing device to align the PCs with each other by aligning the reference points across the PCs with each other.

According to a third aspect there is presented an image processing device for aligning PCs of a physical object. The image processing device comprises an obtain module configured to obtain PCs. Each PC comprises data points and each PC is generated from a respective set of 2D digital images captured of the physical object. The image processing device comprises a localize module configured to localize, in the PCs, data points that correspond to feature points of visual features comprised in the 2D digital images. The image processing device comprises a select module configured to select at least one of the localized data points in each of the PCs as a reference point. The reference points across the PCs represent the same visual feature comprised in the 2D digital images. The image processing device comprises an align module configured to align the PCs with each other by aligning the reference points across the PCs with each other.

According to a fourth aspect there is presented a computer program for aligning PCs of a physical object, the computer program comprising computer program code which, when run on an image processing device, causes the image processing device to obtain PCs, each comprising data points and each being generated from a respective set of 2D digital images captured of the physical object, localize, in the PCs, data points that correspond to feature points of visual features comprised in the 2D digital images, select at least one of the localized data points in each of the PCs as a reference point, wherein the reference points across the PCs represent the same visual feature comprised in the 2D digital images, and align the PCs with each other by aligning the reference points across the PCs with each other.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects enable efficient and accurate alignment of PCs. These aspects are thus suitable for generating DPCs but could also be used for generating SPCs.

Advantageously, these aspects can be combined with weighting factors to enable even further accurately aligned PCs.

Advantageously, these aspects can be combined with known per data point based registration algorithms to increase the accuracy of the alignment of PCs when applying such known per data point based registration algorithms.

Advantageously, these aspects can be used to overcome issues arising from initial differences with respect to distance and rotation between the PCs to be aligned.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 schematically illustrates different views, taken from different types of orbits, of a telecommunication site;

FIG. 2 is a site drawing of a telecommunication site;

FIGS. 3 and 5 are flowcharts of methods according to embodiments;

FIG. 4 schematically illustrates a diagram of aligning PCs according to an embodiment;

FIG. 6 is a schematic diagram showing functional units of an image processing device according to an embodiment;

FIG. 7 is a schematic diagram showing functional modules of an image processing device according to an embodiment; and

FIG. 8 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

As noted above, there is still a need for improved techniques for constructing PCs from images of physical objects

The embodiments disclosed herein therefore relate to mechanisms for aligning PCs of a physical object. In order to obtain such mechanisms there is provided an image processing device 600, 700, a method performed by the image processing device 600, 700, a computer program product comprising code, for example in the form of a computer program, that when run on an image processing device 600, 700, causes the image processing device 600, 700 to perform the method.

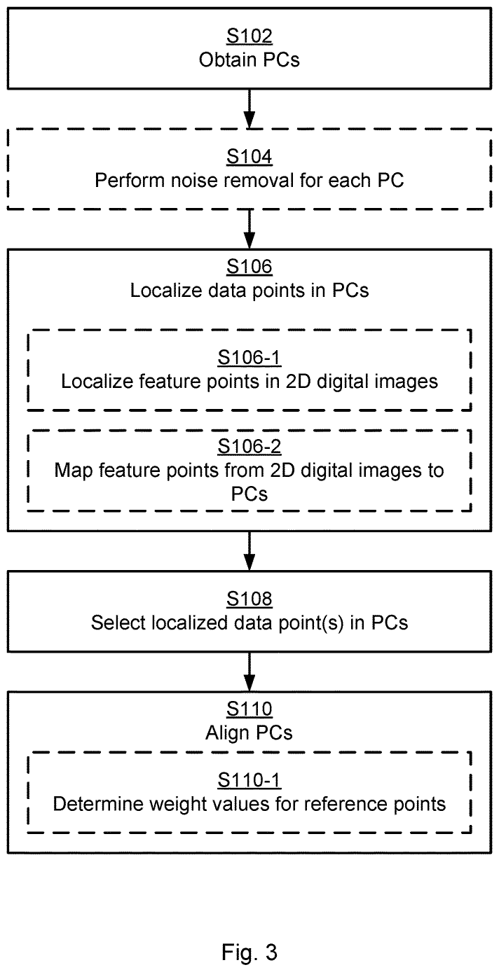

FIG. 3 is a flowchart illustrating embodiments of methods for aligning PCs of a physical object. The methods are performed by the image processing device 600, 700. The methods are advantageously provided as computer programs 820.
S102: The image processing device 600, 700 obtains PCs. Each PC comprises data points. Each PC is generated from a respective set of 2D digital images captured of the physical object.
S106: The image processing device 600, 700 localizes, in the PCs, data points that correspond to feature points of visual features comprised in the 2D digital images.
S108: The image processing device 600, 700 selects at least one of the localized data points in each of the PCs as a reference point. The reference points across the PCs represent the same visual feature comprised in the 2D digital images.
S110: The image processing device 600, 700 aligns the PCs with each other by aligning the reference points across the PCs with each other.

This method enables boosted per-point registration of 3D PCs.

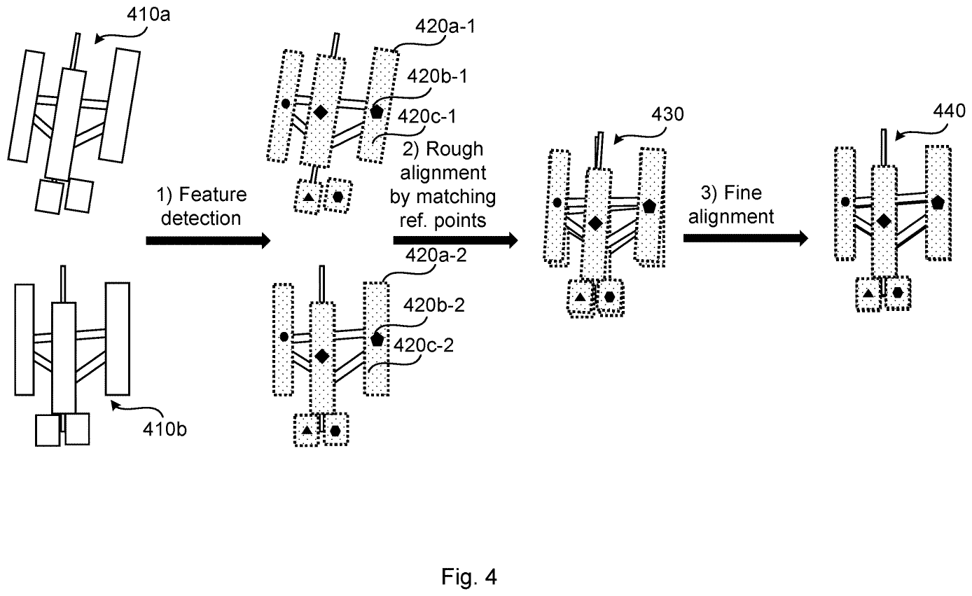

Embodiments relating to further details of aligning PCs of a physical object as performed by the image processing device 600, 700 will now be disclosed. Parallel reference will be made to FIG. 4 which illustrates a diagram of aligning PCs 410a, 410b according to an embodiment. It is noted that whilst the figure and the description below sometimes refer to the alignment of two PCs 410a, 410b, the herein disclosed embodiments are applicable also for the case of aligning more than two PCs.

The PCs could be generated from 2D digital images as captured of the physical object. In some non-limiting examples, the 2D digital images are captured from an image capturing unit mounted on an unmanned aerial vehicle (UAV). In some embodiments, each of the sets of 2D digital images has been captured from a respective orbit around the physical object. The 2D digital images might thereby have been captured from various orbits to enable PCs to be generated from which the physical object can be reconstructed with fine details. Hence, in some examples, the PC is a complete representation of the physical object from any viewing angle, such as a 360-degree representation of the physical object. In other examples, each of the sets of 2D digital images has been captured at a different point in time. In yet further examples, each of the sets of 2D digital images has been captured from the same, or substantially the same, distance, angle, and/or direction with respect to the physical object. Each of the 2D digital images might comprises exchangeable image file format (EXIF) information. This enables the SPCs and the DPCs to be generated based on the EXIF information. EXIF information in terms of positioning information, camera settings, temporal information, etc. can be used when generating the SPCs and the DPCs. Further, the PCs might be generated using a 3D reconstruction software, such as COLMAP, Pix4D, or the like. These methods can be used to recover a sparse reconstruction of the scene depicting the physical object and camera poses of the input 2D digital images. The resulting output can be used as the input to multi-view stereo processing to recover a denser reconstruction of the scene.

In some non-limiting examples, the physical object is a piece of telecommunications equipment, a part of a cell site, or even a complete cell site. In some non-limiting examples, the physical object is a building, or part of a building, or part of a building interior.

In some aspects, background noise removal is performed for each PC before the localization in S106. Hence, in some embodiments, the image processing device 600, 700 is configured to perform (optional) step S104:
S104: The image processing device 600, 700 performs noise removal for each of the PCs before aligning the PCs with each other.

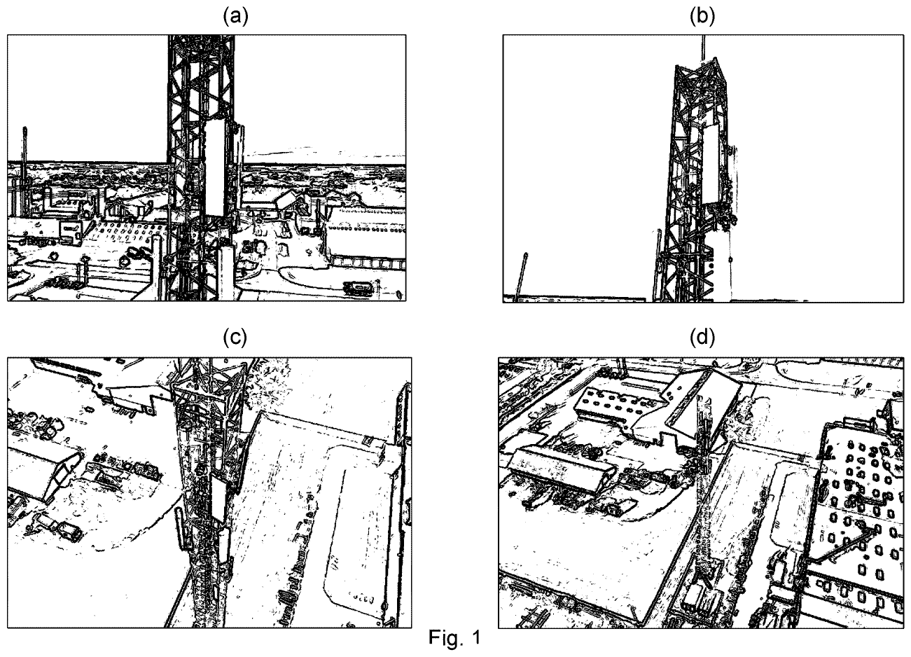

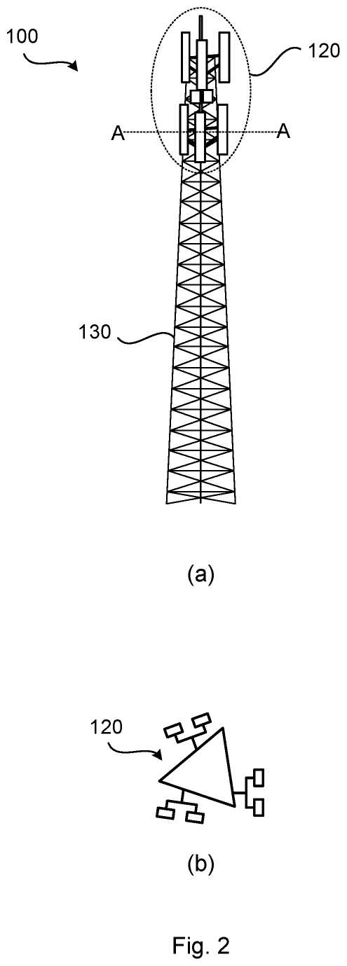

There could be different ways in which the noise removal is performed in step S104. In some examples, the noise removal is performed by a counting-based algorithm. One aspect of counting-based algorithms for noise removal is to only keep data points in a given PC that are shown up in most of the 2D digital images associated with the given PC. For example, in illustrative example of FIG. 1, only the tower structure and its ground facilities would appear in most of the 2D digital images, whereas other structures, such as buildings, trees, clouds, etc. would be defined as background noise and thus be excluded from the PCs.

Further aspects of localizing data points as in step S106 will be disclosed next.

As disclosed above, the image processing device 600, 700 localizes, in the PCs, data points that correspond to feature points of visual features comprised in the 2D digital images. In FIG. 4 this is illustrated by a feature detection step. There could be different examples of such visual features. In some examples, the visual features comprised in the 2D digital images depict any of: edges, corners, parts, of the physical object. The feature points are one or more data points in the PCs, or pixels in the 2D digital images, that belong to the visual features. That is, when the visual features depict an edge of the physical object, the feature points are data points in the PCs, or pixels in the 2D digital images, that belong to the edge. A part of the physical object could be an antenna, a keyboard, a screen, a knob, a lever, etc. In FIG. 4, two corners are illustrated at reference numerals 420a-1, 420a-2.

In some aspects, the feature points are localized directly in the PCs. This could be achieved by using a 3D feature detector or by applying a model according to which the feature points are localized. One non-limiting example method of how to localize feature points directly in PCs is provided in “Comparison of 3D interest point detectors and descriptors for point cloud fusion” by Hänsch, T et al in ISPRS Annals of the Photogrammetry, Remote Sensing and Spatial Information Sciences, Volume II-3, 2014.

In other some aspects, the feature points are first localized in the 2D digital images. These features points are then mapped from the 2D digital images to the PCs. In particular, in in some embodiments, the image processing device 600, 700 is configured to perform (optional) steps S106-1 and S106-2 as part of localizing the data points in step S106:
S106-1: The image processing device 600, 700 localizes, in the 2D digital images, the feature points of the visual features comprised in the 2D digital images.
S106-2: The image processing device 600, 700 maps the feature points from the 2D digital images to the PCs to aid localizing the data points in the PCs that correspond to the feature points of the visual features comprised in the 2D digital images.

A visual object detector can be applied for localizing feature points of the physical object in the 2D digital images. For example, the visual object detector could be implemented using segmentation algorithms. Non-limiting examples of segmentation algorithms that can be used for this purpose are Mask RCNN, YOLACT, MaskLab, and TensorMask. Then, those feature points are projected, or mapped, to localize the corresponding data points in the PCs.

Further details relating to the case where the feature points are first localized in the 2D digital images and then mapped from the 2D digital images to the PCs will be disclosed next.

A segmentation operation, for example trained on images depicting similar types of physical objects, can be applied to each 2D digital image. This could help to identify the physical object at pixel level. Non-limiting examples of segmentation algorithms that can be used for this purpose have been listed above.

Edge detection, e.g., a canny edge detector or similar, can be applied to find all edge points, as well as corner points, of the physical object.

The feature points can then be selected from the found edge points or corner points. The data points in the PCs could then be mapped to the 2D digital images so that the feature points selected in the 2D digital images can be mapped, or projected to, to the PCs. In this respect, the mapping, or projection, for a given PC is jointly based on the feature points selected in all the 2D digital images of that given PC.

As disclosed above, the image processing device 600, 700 aligns the PCs with each other by aligning the reference points across the PCs with each other. There could be different examples of such reference points. In some non-limiting examples, the reference points represent any of: a centroid, a corner, an edge, of the physical object. In FIG. 4, two reference points are illustrated at the pentagrams at reference numerals 420b-1, 420b-2. Further possible reference points are schematically indicated at the black circles, ellipsoids, triangles, and squares in FIG. 4. The centroid generally represents the center of gravity. Hence, although the centroid is used as a reference point in some examples other reference points could also be used, e.g., an upper-right, lower-right, upper-left, or upper-right corner. In some examples, the PCs are aligned based on at least two reference points in each PCs. This could increase the robustness of the alignment. However, in some examples it might be sufficient to use one single reference point in each PC.

Once the PCs have been aligned with each other by means of their reference points, as indicated in FIG. 4 by a step of rough alignment by matching reference points, a transformation matrix can be calculated and applied to further align the PCs. This further alignment of the PCs is in FIG. 4 indicated by a step of fine alignment. FIG. 4 further illustrates roughly aligned PCs at reference numeral 430 and finely aligned PCs at reference numeral 440. How to finely align the PCs 430 will be disclosed in further detail below.

In some aspects, the alignment of the PCs is based on weighted data points. In particular, weighting values might be determined at least for the reference points such that the reference points are weighted higher than any other data points when the PCs are aligned. In some embodiments, the image processing device 600, 700 is therefore configured to perform (optional) step S110-1 as part of aligning the PCs with each other:
S110-1: The image processing device 600, 700 determines weighting values for the reference points. The reference points are weighted higher than any other data points in the PCs when the PCs are aligned with each other.

In general terms, the weighting values impact the error in the registration process, and thus of the alignment. As will be disclosed in further examples below, the weighing values might be used to modify a cost function used during the registration process.

In some examples, weighting values are set at different levels, for example depending on the type of data points: the weighting values might be set to be comparatively high for reference points, comparatively lower for data points that are not reference points but still represent edges and/or corners of the physical object, and comparatively lowest for remaining data points neither being reference points nor representing edges and/or corners of the physical object. In some embodiments, weighting values are therefore determined also for other data points than the reference points. The data points representing edges and/or corners of the physical object might then be weighted higher than the data points representing surfaces of the physical object but are weighted lower than the reference points. One reason for weighting the data values is that data points representing parts of the physical object that lie on surfaces are less reliable for use in the PC alignment procedure. The values of such data points, as well as the number of such data points change with lightning conditions and camera pose. Data points not representing the physical object are also not reliable due to thin structures and incorrectly assigned depth values, as clouds in the sky, etc. In FIG. 4 is schematically illustrated at reference numerals 420c-1, 420c-2 data points that are on the surface of the physical object. The PCs with weighted reference points can be input to guide a per point criterion alignment, or registration, algorithm. That is, aligning the PCs with each other might comprise applying a per data point based registration algorithm to the PCs. There could be different examples of per data point based registration algorithm. For example, the per data point based registration algorithm could be an ICP algorithm or any of its variants.

In some aspects, the weighting values are applied during a transformation process of the per data point based registration algorithm. Hence, in some embodiments, the per data point based registration algorithm involves subjecting the PCs to a transformation procedure, and the weighting values are used during the transformation procedure.

A two-stage alignment procedure can thus be executed by firstly roughly aligning the PCs according to the reference points, and then finely aligning the PCs using weighted data points.

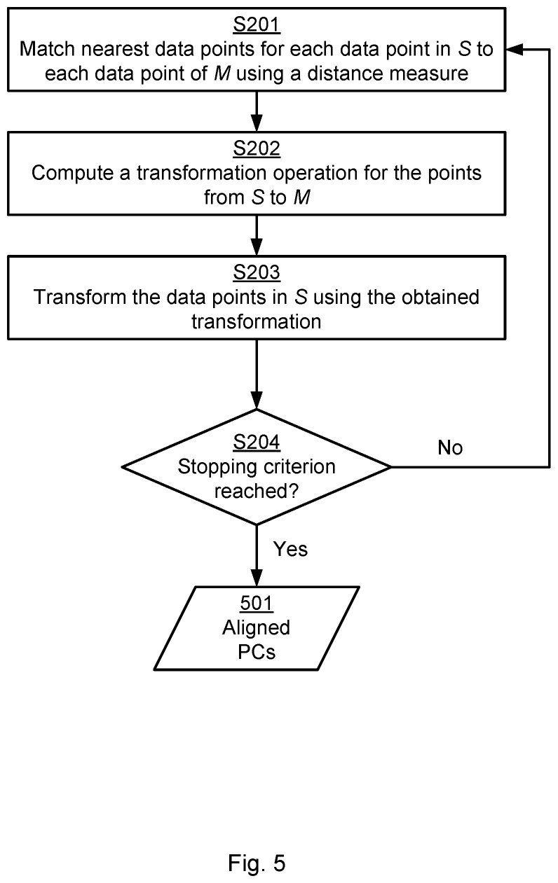

An example algorithm based on at least some of the above disclosed embodiments, aspects, and examples, will be presented next with reference to the flowchart of FIG. 5. The algorithm can be implemented by and/or executed by, the image processing device 600, 700. Assume that there are two PCs, denoted S and M that are to be aligned with each other.
S201: Match nearest data points for each data point in S to each data point of M using a certain distance measure, e.g., Euclidean distance:

$${d}_{i} = min ( \sqrt{{( {m}_{i} - {s}_{j} )}^{2}} , for all i = 1 to \vert M \vert , and all j = 1 to \vert S \vert$$

If dᵢ is larger than a threshold distance, the point dᵢ and its data point pair (mᵢ, sⱼ) is removed.
S202: Compute a transformation operation (in terms of rotation and translation) for the data points from S to M, e.g., using a least square method to minimize an error metric, or cost function E(R,t):

$$E ( R , t ) = {\sum }_{i = 1}^{\vert M \vert} {\sum }_{j = 1}^{\vert S \vert} {w}_{ij} \cdot \sqrt{( {m}_{i} - {( R \cdot {s}_{j} + t )}^{2}}$$

Here, R is a rotation operation and t is a translation operation to be applied to the PC. Further, wᵢⱼ are the weighting values for the corresponding data points. The weighing values are thereby used to modify the cost function E(R, t).
S203: Transform the data points in S using the obtained transformation (R, t).
S204: Check if a stopping criterion has been reached, e.g., a predetermined number of iterations have been performed, or a difference in S between two consecutive iterations is smaller than a predetermined threshold value. If stopping criterion has not been reached, reiterate S201-S203. The data point in S and the data points in M once the stopping criterion has been reached collectively define the aligned PCs, as indicated by box 501.

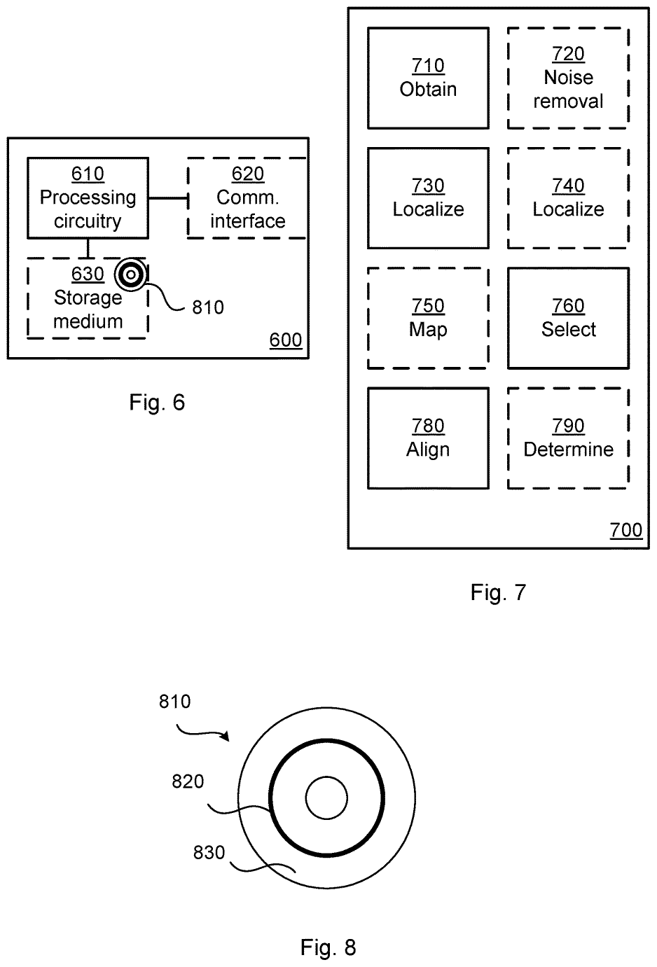

FIG. 6 schematically illustrates, in terms of a number of functional units, the components of an image processing device 600 according to an embodiment. Processing circuitry 610 is provided using any combination of one or more of a suitable central processing unit (CPU), multiprocessor, microcontroller, digital signal processor (DSP), etc., capable of executing software instructions stored in a computer program product 810 (as in FIG. 8), e.g. in the form of a storage medium 630. The processing circuitry 610 may further be provided as at least one application specific integrated circuit (ASIC), or field programmable gate array (FPGA).

Particularly, the processing circuitry 610 is configured to cause the image processing device 600 to perform a set of operations, or steps, as disclosed above. For example, the storage medium 630 may store the set of operations, and the processing circuitry 610 may be configured to retrieve the set of operations from the storage medium 630 to cause the image processing device 600 to perform the set of operations. The set of operations may be provided as a set of executable instructions.

Thus the processing circuitry 610 is thereby arranged to execute methods as herein disclosed. The storage medium 630 may also comprise persistent storage, which, for example, can be any single one or combination of magnetic memory, optical memory, solid state memory or even remotely mounted memory. The image processing device 600 may further comprise a communications interface 620 at least configured for communications with other entities, functions, nodes, and devices. As such the communications interface 620 may comprise one or more transmitters and receivers, comprising analogue and digital components. The processing circuitry 610 controls the general operation of the image processing device 600 e.g. by sending data and control signals to the communications interface 620 and the storage medium 630, by receiving data and reports from the communications interface 620, and by retrieving data and instructions from the storage medium 630. Other components, as well as the related functionality, of the image processing device 600 are omitted in order not to obscure the concepts presented herein.

FIG. 7 schematically illustrates, in terms of a number of functional modules, the components of an image processing device 700 according to an embodiment. The image processing device 700 of FIG. 7 comprises a number of functional modules; an obtain module 710 configured to perform step S102, a localize module 730 configured to perform step S106, a select module 760 configured to perform step S108, and an align module 780 configured to perform step S110. The image processing device 700 of FIG. 7 may further comprise a number of optional functional modules, such as any of a noise removal module 720 configured to perform step S104, a localize module 740 configured to perform step S106-1, a map module 750 configured to perform step S106-2, and a determine module 790 configured to perform step S110-1.

In general terms, each functional module 710:790 may in one embodiment be implemented only in hardware and in another embodiment with the help of software, i.e., the latter embodiment having computer program instructions stored on the storage medium 630 which when run on the processing circuitry makes the image processing device 700 perform the corresponding steps mentioned above in conjunction with FIG. 7. It should also be mentioned that even though the modules correspond to parts of a computer program, they do not need to be separate modules therein, but the way in which they are implemented in software is dependent on the programming language used. Preferably, one or more or all functional modules 710:790 may be implemented by the processing circuitry 610, possibly in cooperation with the communications interface 620 and/or the storage medium 630. The processing circuitry 610 may thus be configured to from the storage medium 630 fetch instructions as provided by a functional module 710:790 and to execute these instructions, thereby performing any steps as disclosed herein.

Any method disclosed herein can be executed by an image processing device 600, 700 implemented a centralized location, e.g., a computational server in a data center, that has access to 2D digital images from which PCs are to be aligned. The image processing device 600, 700 may be provided as a standalone device or as a part of at least one further device. For example, the image processing device 600, 700 may be provided in a node of the radio access network or in a node of the core network. Alternatively, functionality of the image processing device 600, 700 may be distributed between at least two devices, or nodes. These at least two nodes, or devices, may either be part of the same network part or may be spread between at least two such network parts. Thus, a first portion of the instructions performed by the image processing device 600, 700 may be executed in a first device, and a second portion of the of the instructions performed by the image processing device 600, 700 may be executed in a second device; the herein disclosed embodiments are not limited to any particular number of devices on which the instructions performed by the image processing device 600, 700 may be executed. Hence, the methods according to the herein disclosed embodiments are suitable to be performed by an image processing device 600, 700 residing in a cloud computational environment. Therefore, although a single processing circuitry 610 is illustrated in FIG. 6 the processing circuitry 610 may be distributed among a plurality of devices, or nodes. The same applies to the functional modules 710:790 of FIG. 7 and the computer program 820 of FIG. 8.

FIG. 8 shows one example of a computer program product 810 comprising computer readable storage medium 830. On this computer readable storage medium 830, a computer program 820 can be stored, which computer program 820 can cause the processing circuitry 610 and thereto operatively coupled entities and devices, such as the communications interface 620 and the storage medium 630, to execute methods according to embodiments described herein. The computer program 820 and/or computer program product 810 may thus provide means for performing any steps as herein disclosed.

In the example of FIG. 8, the computer program product 810 is illustrated as an optical disc, such as a CD (compact disc) or a DVD (digital versatile disc) or a Blu-Ray disc. The computer program product 810 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 820 is here schematically shown as a track on the depicted optical disk, the computer program 820 can be stored in any way which is suitable for the computer program product 810.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1-22. (canceled)

23. A method for aligning point clouds (PCs) of a physical object, the method being performed by an image processing device, the method comprising:
obtaining PCs, each comprising data points and each being generated from a respective set of two-dimensional (2D) digital images captured of the physical object;
localizing, in the PCs, data points that correspond to feature points of visual features comprised in the 2D digital images;
selecting at least one of the localized data points in each of the PCs as a reference point, wherein the reference points across the PCs represent the same visual feature comprised in the 2D digital images; and
aligning the PCs with each other by aligning the reference points across the PCs with each other.

24. The method according to claim 23, wherein localizing the data points further comprises:
localizing, in the 2D digital images, the feature points of the visual features comprised in the 2D digital images; and
mapping the feature points from the 2D digital images to the PCs to aid localizing the data points in the PCs that correspond to the feature points of the visual features comprised in the 2D digital images.

25. The method according to claim 23, wherein aligning the PCs with each other further comprises:
determining weighting values for the reference points, whereby the reference points are weighted higher than any other data points in the PCs when the PCs are aligned with each other.

26. The method according to claim 25, wherein weighting values are determined also for other data points than the reference points, whereby the data points representing edges and/or corners of the physical object are weighted higher than the data points representing surfaces of the physical object but are weighted lower than the reference points.

27. The method according to claim 23, wherein aligning the PCs with each other comprises applying a per data point based registration algorithm to the PCs.

28. The method according to claim 27, wherein the per data point based registration algorithm involves subjecting the PCs to a transformation procedure, and wherein the weighting values are used during the transformation procedure.

29. The method according to claim 27, wherein the per data point based registration algorithm is an iterative closest point, ICP, algorithm.

30. The method according to claim 23, wherein the method further comprises: performing noise removal for each of the PCs before aligning the PCs with each other.

31. The method according to claim 30, wherein the noise removal is performed by a counting-based algorithm.

32. The method according to claim 23, wherein the visual features comprised in the 2D digital images depict any of: edges, corners, parts, of the physical object.

33. The method according to claim 23, wherein the reference points represent any of: a centroid, a corner, an edge, of the physical object.

34. The method according to claim 23, wherein each of the sets of 2D digital images has been captured from a respective orbit around the physical object.

35. The method according to claim 23, wherein each of the sets of 2D digital images has been captured at a different point in time.

36. The method according to claim 23, wherein each of the sets of 2D digital images has been captured from same distance, angle, and/or direction with respect to the physical object.

37. The method according to claim 23, wherein the 2D digital images have been captured from an image capturing unit mounted on an unmanned aerial vehicle (UAV).

38. The method according to claim 23, wherein the physical object is a telecommunications equipment.

39. The method according to claim 23, wherein the physical object is a building, a part of a building, or part of a building interior.

40. An image processing device for aligning point clouds (PCs) of a physical object, the image processing device comprising processing circuitry, the processing circuitry being configured to cause the image processing device to:
obtain PCs, each comprising data points and each being generated from a respective set of two-dimensional (2D) digital images captured of the physical object;
localize, in the PCs, data points that correspond to feature points of visual features comprised in the 2D digital images;
select at least one of the localized data points in each of the PCs as a reference point, wherein the reference points across the PCs represent the same visual feature comprised in the 2D digital images; and
align the PCs with each other by aligning the reference points across the PCs with each other.

41. An image processing device for aligning point clouds (PCs) of a physical object, the image processing device comprising:
an obtain module configured to obtain PCs, each comprising data points and each being generated from a respective set of two-dimensional (2D) digital images captured of the physical object;
a localize module configured to localize, in the PCs, data points that correspond to feature points of visual features comprised in the 2D digital images;
a select module configured to select at least one of the localized data points in each of the PCs as a reference point, wherein the reference points across the PCs represent the same visual feature comprised in the 2D digital images; and
an align module configured to align the PCs with each other by aligning the reference points across the PCs with each other.

42. A non-transitory computer readable medium storing a computer program for aligning point clouds (PCs) of a physical object, the computer program comprising computer code which, when run on processing circuitry of an image processing device, causes the image processing device to:
obtain PCs, each comprising data points and each being generated from a respective set of two-dimensional (2D) digital images captured of the physical object;
localize, in the PCs, data points that correspond to feature points of visual features comprised in the 2D digital images;
select at least one of the localized data points in each of the PCs as a reference point, wherein the reference points across the PCs represent the same visual feature comprised in the 2D digital images; and
align the PCs with each other by aligning the reference points across the PCs with each other.
